(19) United States
(12) Patent Application Publication
(10) Pub. No.: US 2012/0303809 A1
(43) Pub. Date: Nov. 29, 2012

(54) OFFLOADING LOAD BALANCING PACKET MODIFICATION

(75) Inventors: Parveen Patel, Redmond, WA (US); Deepak Bansal, Redmond, WA (US); Changhoon Kim, Bellevue, WA (US); Marios Zikos, Alexandroupolis (GR); Volodymyr Ivanov, Sammamish, WA (US)

(73) Assignee: Microsoft Corporation, Redmond, WA (US)

(21) Appl. No.: 13/115,444

(22) Filed: May 25, 2011

(51) Int. Cl. G06F 15/16

(52) U.S. Cl. 709/225; 709/228

(57) ABSTRACT

The present invention extends to methods, systems, and computer program products for off loading load balancing packet modification. Embodiments of the invention can be used to offload the load of forwarding packets back to packet senders. Load balancers and/or the NAT devices can handle the first few packets of a connection to formulate connection mappings and then are removed from further communication for the connections. For example, a load balancer or NAT device makes the corresponding load balancing or the NAT decision based on a first packet and then informs the sender of the data of the decision. From then on, the sender can directly send the data to the receiver without having to go through the load balancer or NAT.

### CROSS-REFERENCE TO RELATED APPLICATIONS

Not Applicable.

### BACKGROUND

1. Background and Relevant Art

Computer systems and related technology affect many aspects of society. Indeed, the computer system's ability to process information has transformed the way we live and work. Computer systems now commonly perform a host of tasks (e.g., word processing, scheduling, accounting, etc.) that prior to the advent of the computer system were performed manually. More recently, computer systems have been coupled to one another and to other electronic devices to form both wired and wireless computer networks over which the computer systems and other electronic devices can transfer electronic data. Accordingly, the performance of many computing tasks are distributed across a number of different computer systems and/or a number of different computing environments.

In distributed computing systems, distributed load balancers are often used to share processing load across a number of computer systems. For example, a plurality of load balancers can be used to receive external communication directed to a plurality of processing endpoints. Each load balancer has some mechanism to ensure that all external communication from the same origin is directed to the same processing endpoint.

These mechanisms often include load balancers exchanging state with one another. For example, a decision made at one load balancer for communication for specified origin can be synchronized across other load balancers. Based on the synchronized state, any load balancer can then make an accurate decision with respect to sending communication from the specified origin to the same processing endpoint.

Unfortunately, to maintain synchronized state among a plurality of load balancers, significant quantities of data often need to be exchanged between the plurality of load balancers. As a result, synchronizing state among load balancers usually becomes a bottleneck and limits the scalability of load balancers.

Further, since each load balancer has limited resources, as external communication directed a plurality of endpoints increases the number of load balancers must also corresponding increase. In some environments, a plurality of load balancers and a number of different pluralities of endpoints are under the control of a common network domain. In these environments, within the common network domain, one load balancer can balance the load across a first plurality of endpoints and another load balancer can balance the load across a second different plurality of endpoints.

From time to time, endpoints can participate in inter-endpoint communication. For example, a first endpoint in one plurality of endpoints can communicate with a second endpoint in another different plurality of endpoints and vice versa. To facilitate communication, the first endpoint can identify the load balancer for the other plurality of endpoints as the destination for packets. The first endpoint can then send the packets onto a computer network (e.g., the Internet). The network routes the packets back to the load balancer for the other plurality of endpoints. The load balancer for the other plurality of endpoints then selects the second endpoint as the destination. The second endpoint uses a similar mechanism to communicate back to the first endpoint.

As such, inter-endpoint communication increases the burden on the load balancers, potentially limiting the forwarding capacity available for communication from external sources. If inter-endpoint communication is significant, limits to the forwarding capacity of a load balancer can become a bottleneck that determines the maximum bandwidth supported by the load balancer.

### BRIEF SUMMARY

The present invention extends to methods, systems, and computer program products for offloading load balancing packet modification. A computer system includes a router and a packet modification system (e.g., a load balancing or Network Address Translation (“NAT”) system) within a common network domain. The packet modification system includes a first packet modifier (e.g., a load balancer or NAT device), a second packet modifier (e.g., another load balancer or NAT device), a first plurality of destination hosts, and a second plurality of destination hosts. The router is connected to a computer network and is a point of ingress from the computer network into the load balancing system.

A sending destination host, in the first plurality of destination hosts, sends a packet onto the computer network. The packet is for a connection directed to the second plurality of destination hosts. The packet includes a source electronic address for the sending destination host and a destination electronic address for the second packet modifier.

The second packet modifier receives the packet for the connection directed to the second plurality of host destinations. The second packet modifier determines that the second packet modifier is to forward the packet to a receiving destination host in the second plurality of destination hosts. As such, the second packet modifier forwards the packet to the receiving destination host.

The second packet modifier detects that the sending destination host is within the common network domain. The second packet modifier formulates a connection mapping for the connection. The connection mapping maps the connection to an electronic address for the receiving destination host. The second packet modifier sends the connection mapping directly to the electronic address for the sending destination host.

The sending destination host receives the connection mapping for the connection directly from the second packet modifier. Subsequently, the sending destination host utilizes the connection mapping to bypass the second packet modifier and send a second packet for the connection directly to the receiving destination host.

Similar mechanisms can also be used to permit the receiving destination host to bypass the first packet modifier and send packets for the connection directly to the sending destination host.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1A illustrates an example computer architecture that facilitates offloading load balancing packet modifications.

FIG. 1B illustrates another example computer architecture that facilitates offloading load balancing packet modifications.

FIG. 2 illustrates a flow chart of an example method for offloading load balancing packet modifications.

### DETAILED DESCRIPTION

The present invention extends to methods, systems, and computer program products for off loading load balancing packet modification. A computer system includes a router and a packet modification system (e.g., a load balancing system or Network Address Translation (“NAT”) system) within a common network domain. The packet modification system includes a first packet modifier (e.g., a load balancer or NAT device), a second packet modifier (e.g., another load balancer or NAT device), a first plurality of destination hosts, and a second plurality of destination hosts. The router is connected to a computer network (e.g, the Internet) and is a point of ingress from the computer network into the load balancing system.

A sending destination host, in the first plurality of destination hosts, sends a packet onto the computer network. The packet is for a connection directed to the second plurality of destination hosts. The packet includes a source electronic address for the sending destination host and a destination electronic address for the second packet modifier.

The second packet modifier receives the packet for the connection directed to the second plurality of host destinations. The second packet modifier determines that the second packet modifier is to forward the packet to a receiving destination host in the second plurality of destination hosts. As such, the second packet modifier forwards the packet to the receiving destination host.

The second packet modifier detects that the sending destination host is within the common network domain. The second packet modifier formulates a connection mapping for the connection. The connection mapping maps the connection to an electronic address for the receiving destination host. The second packet modifier sends the connection mapping directly to the electronic address for the sending destination host.

The sending destination host receives the connection mapping for the connection directly from the second packet modifier. Subsequently, the sending destination host utilizes the connection mapping to bypass the second packet modifier and send a second packet for the connection directly to the receiving destination host.

Similar mechanisms can also be used to permit the receiving destination host to bypass the first packet modifier and send packets for the connection directly to the sending destination host.

Embodiments of the present invention may comprise or utilize a special purpose or general-purpose computer including computer hardware, such as, for example, one or more processors and system memory, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: computer storage media (devices) and transmission media.

Computer storage media (devices) includes RAM, ROM, EEPROM, CD-ROM or other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry or desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that computer storage media (devices) can be included in computer system components that also (or even primarily) utilize transmission media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

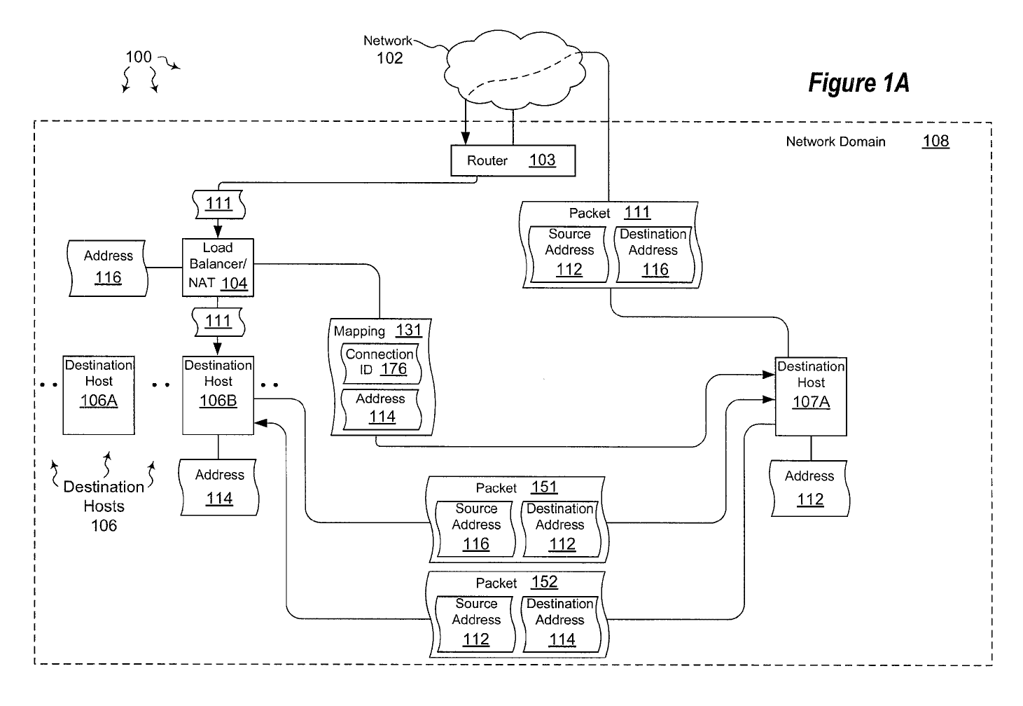

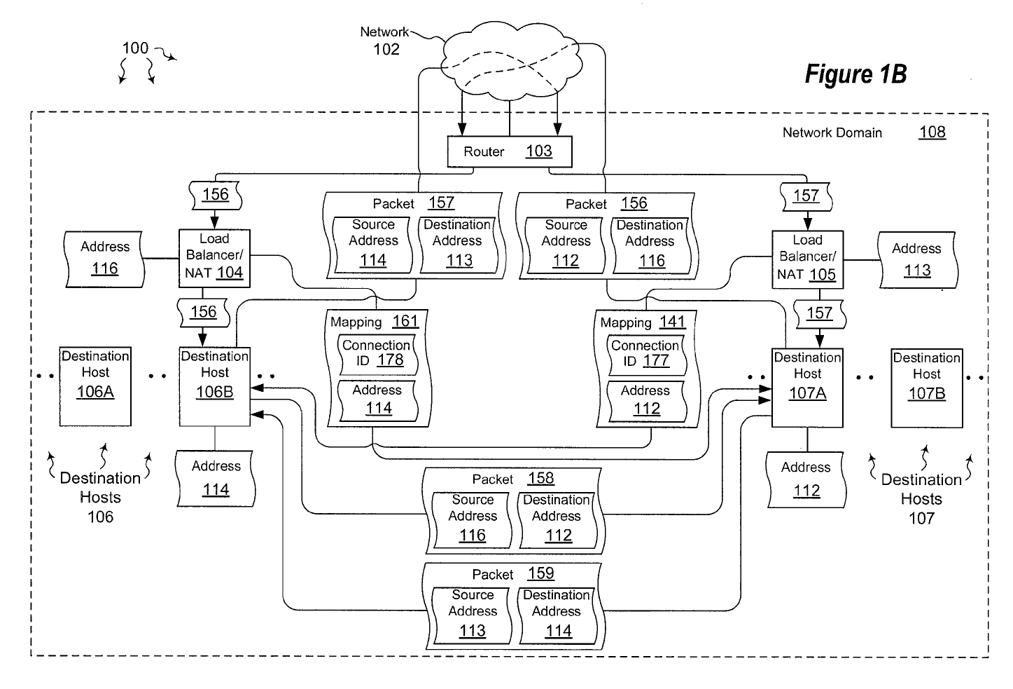

FIG. 1A illustrates an example computer architecture 100 that facilitates off loading load balancing packet modification. Referring to FIG. 1, computer architecture 100 includes network 102 and network domain 108. Network 102 can represent a Wide Area Network (“WAN”), such as, for example, the Internet. Network domain 108 contains router 103, load balancer/Network Address Translator (“NAT”) 104, load balancer/NAT 105 destination hosts 106, and destination host 107A. With network domain 108, each of the depicted components is connected to one another over (or is part of) a further network, such as, for example, a Local Area Network (“LAN”) or further (e.g., corporate) Wide Area Network (“WAN”). Accordingly, each of the depicted components as well as any other connected computer systems and their components, can create message related data and exchange message related data (e.g., Internet Protocol (“IP”) datagrams and other higher layer protocols that utilize IP datagrams, such as, Transmission Control Protocol (“TCP”), Hypertext Transfer Protocol (“HTTP”), Simple Mail Transfer Protocol (“SMTP”), etc.) over the network and the further network.

Generally, router 103 serves as a point of ingress for communication on network 102 (possibly from external components) to pass into network domain 108. Router 103 can receive communication via network 102 and identify a component within network domain 108 that is to receive the communication. Upon receiving communication, router 103 can refer to a destination address in the received communication to determine where to send the communication. For example, when receiving a IP packet, router 103 can refer to a destination IP address to determine where to send the IP packet with network domain 108.

Load balancer/NAT 104 can balance a communication load across destination hosts 106. When load balancer/NAT 104 receives communication (e.g., from router 103), load balancer/NAT 104 determines which instance of destination hosts 106 is to receive the communication. Although depicted as a single component, load balancer/NAT 104 can be a distributed load balancer. For example, load balancer/NAT 104 can include a plurality of load balancer instances that interoperate (and share state when appropriate) to balance the communication load across destination hosts 106. As depicted, destination hosts 106 include a plurality of destination hosts, including destination hosts 106A, 106B, etc. Each destination host 106 can be an instance of the same component, such as, for example, a Web service, an API, a Remote Procedure Call (“RPC”), etc.

Destination host 107A can be a single destination host.

In some embodiments, destination host 107A sends packet 111 onto network 102. As depicted, packet 111 includes source address 112 (e.g., an IP address for destination host 107A) and destination address 116 (e.g., an IP address for plurality of hosts 106).

Components on network 102 can determine that router 103 is responsible for destination address 116 (e.g., a virtual IP address corresponding to destination hosts 106 collectively). As such, components within network 102 (e.g., other routers) can route packet 111 to router 103. Alternately, router 103 can detect responsibility for packet 111 and take control of packet 111 before it enters onto network 102. In any event, router 103 can determine that address 116 is to be sent via the load balancer/NAT 104. Accordingly, router 103 can send packet 111 to load balancer/NAT 104.

Load balancer/NAT 104 can receive packet 111 from router 103. Source address 112 indicates that packet 111 originated from destination host 107A. Load balancer/NAT 104 can determine that load balancer/NAT 104 is to forward packet 111 to destination host 106B. Load balancer/NAT 104 can use a load balancing algorithm (e.g., for a new connection) and/or refer to saved state (e.g., for an existing connection) to determine packet 111 is to be forwarded to destination host 106B.

Load balancer/NAT 104 can forward packet 111 to destination host 106B. Load balancer/NAT 104 can map destination address 116 (e.g., a virtual IP address) to address 114 (e.g., an IP address) corresponding to destination host 106B. Destination host 106B can receive packet 111 from load balancer/NAT 104.

Load balancer/NAT 104 can formulate mapping 131. Mapping 131 maps connection ID 176 (an identifier for the connection) to address 114 (e.g., an IP address for destination host 106B). Load balancer/NAT 104 can create (if new) or access (if existing) connection ID 176 for the connection. Load balancer/NAT 104 can create connection ID 176 based on components of source address 112, destination address 116, and other packet contents that uniquely identify the connection (e.g., IP address and port).

Load balancer/NAT 104 can send mapping 131 directly to destination host 107A. Destination host 107A can receive mapping 131 from load balancer/NAT 104. Destination host 107A can subsequently utilize mapping 131 to bypass load balancer/NAT 104 and send packet 152 directly to destination host 106B. As depicted, packet 152 includes source address 112 and destination address 114. This information as well as other packet information can be used to map packet 152 to connection ID 176. Accordingly, packets 111 and 152 can be viewed as part of the same packet flow.

Destination host 106B can also send packets directly to destination host 107A. For example, destination host 106B can send packet 151 directly to destination hosts 107A. As depicted, packet 151 includes source address 116 and destination address 112.

FIG. 1B illustrates another example computer architecture 100 that facilitates off loading load balancing packet modification. As depicted, FIG. 1B further includes load balancer/NAT 105. Additional destination hosts 107B, etc. are grouped with destination host 107A in destination hosts 107.

Similar to load balancer/NAT 104 load balancer/NAT 105 can balance a communication load across destination hosts 107. When load balancer/NAT 105 receives communication (e.g., from router 103), load balancer/NAT 105 determines which instance of destination hosts 107 is to receive the communication. Although depicted as a single component, load balancer/NAT 105 can be a distributed load balancer. For example, load balancer/NAT 105 can include a plurality of load balancer instances that interoperate (and share state when appropriate) to balance the communication load across destination hosts 107. As depicted, destination hosts 107 include a plurality of destination hosts, including destination hosts 107A, 107B, etc. Each destination host 107 can be an instance of the same component, such as, for example, a Web service, an API, a RPC, etc.

Each of load balancers 104 and 105 can include load balancing and/or Network Address Translation (“NAT”) functionality.

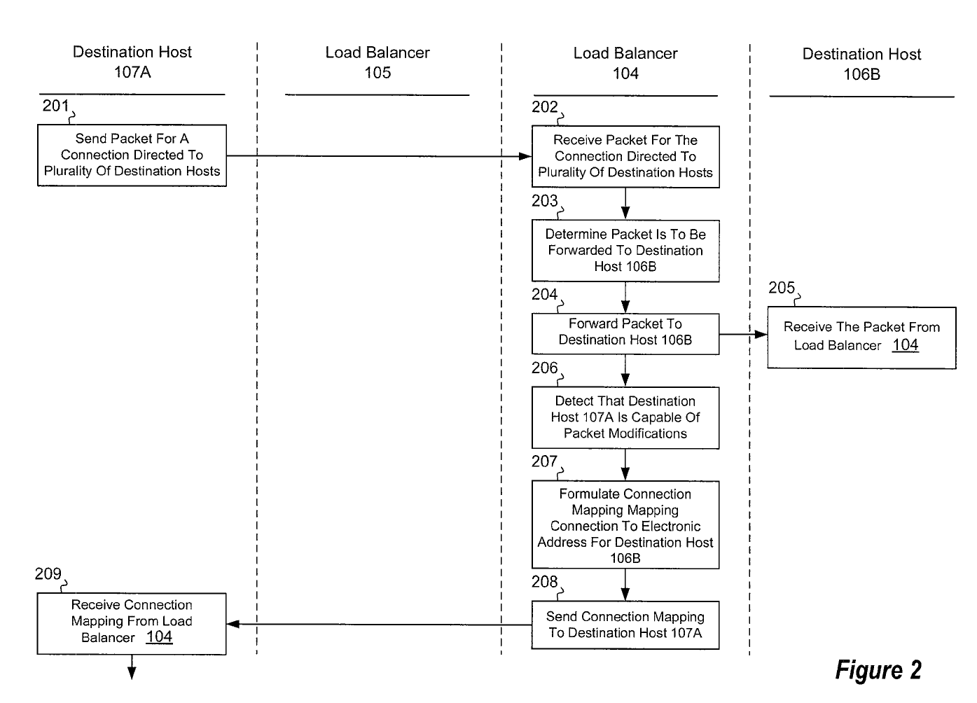

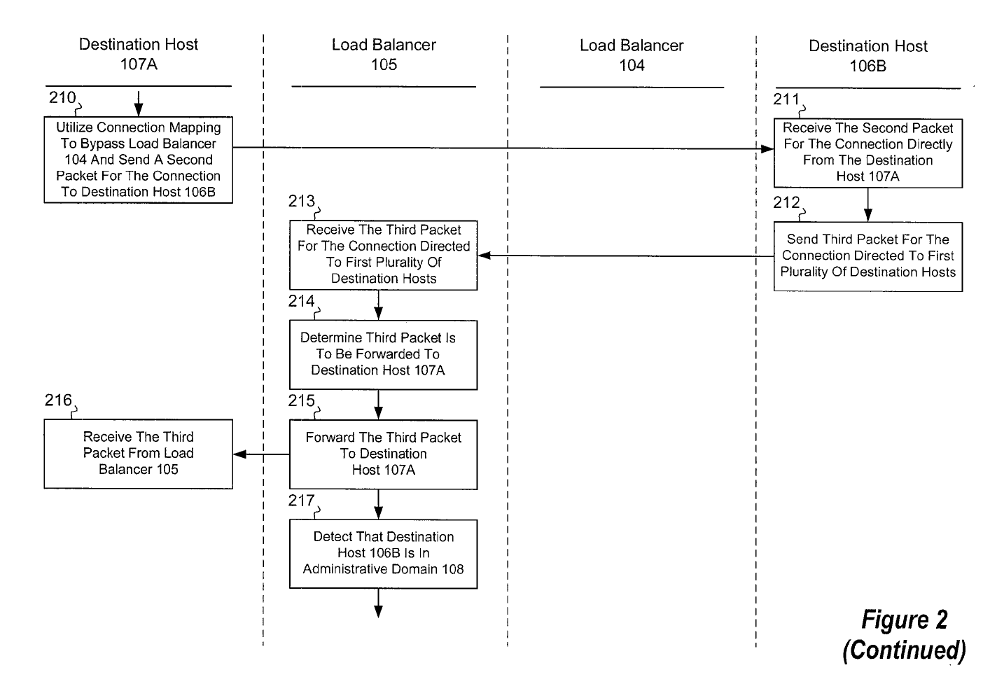

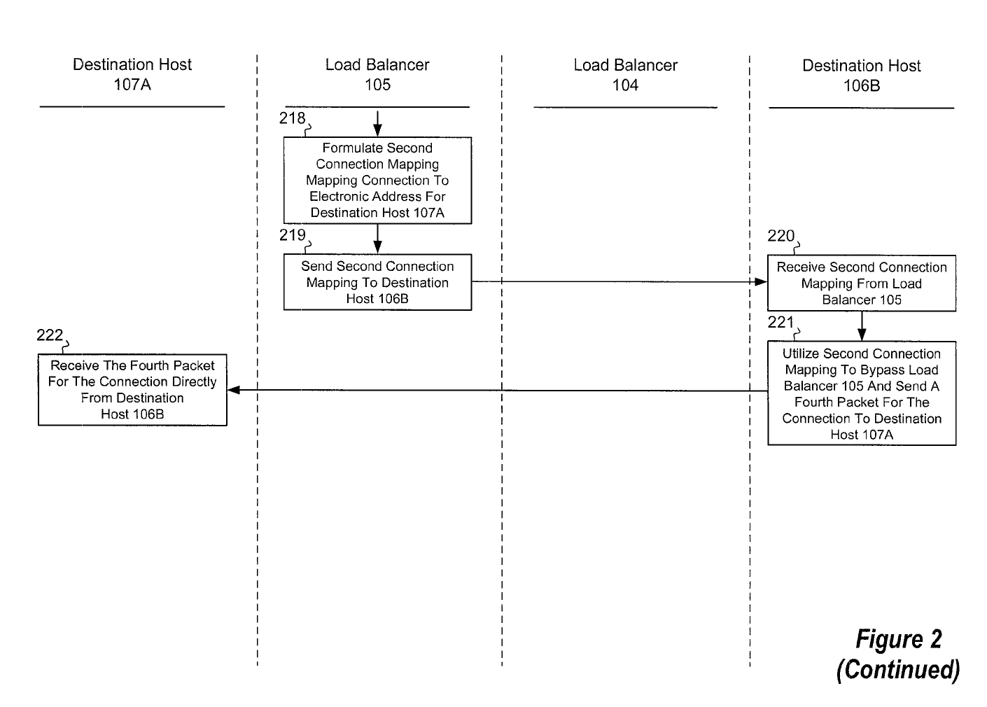

FIG. 2 illustrates a flow chart of an example method 200 for off loading load balancing packet modification. Method 200 will be described with respect to the components and data of computer architecture 100.

Method 200 includes an act of sending a packet for a connection directed to a plurality of destination hosts (act 201). Act 201 can include a sending destination host, in the first plurality of destination hosts, sending a packet onto a computer network. The packet is for a connection directed to a second plurality of destination hosts. The packet includes a source electronic address for the sending destination host and destination electronic address for the second plurality of destination hosts. For example, destination host 107A can send packet 156 onto network 102. As depicted, packet 156 includes source address 112 (e.g., an IP address for destination host 107A) and destination address 116 (e.g., an IP address for plurality of hosts 106).

Components on network 102 can determine that router 103 is responsible for destination address 116 (e.g., a virtual IP address corresponding to destination hosts 106 collectively). As such, components within network 102 (e.g., other routers) can route packet 156 to router 103. Alternately, router 103 can detect responsibility for packet 156 and take control of packet 156 before it enters onto network 102. In any event, router 103 can determine that address 116 is to be sent via the load balancer/NAT 104. Accordingly, router 103 can send packet 156 to load balancer/NAT 104.

Method 200 includes an act of receiving the packet for the connection directed to the plurality of destination hosts (act 202). Act 202 can include the second load balancer receiving the packet for the connection directed to the second plurality of destination hosts. The packet including an electronic address indicating that the packet originated from a sending destination host in the first plurality of destination hosts. For example, load balancer/NAT 104 can receive packet 156 from router 103. Source address 112 indicates that packet 156 originated from destination host 107A.

In some embodiments, packet 156 can have originated from a virtual IP address that hides actual IP address for destination hosts included in destination hosts 107.

Method 200 includes an act of determining that the packet is to be forwarded to a receiving destination host (act 203). Act 203 can include the second load balancer determining that the second load balancer is to forward packets for the connection to a receiving destination host in the second plurality of destination hosts. For example, load balancer/NAT 104 can determine that load balancer/NAT 104 is to forward packet 156 to destination host 106B. Load balancer/NAT 104 can use a load balancing algorithm (e.g., for a new connection) and/or refer to saved state (e.g., for an existing connection) to determine packet 156 is to be forwarded to destination host 106B.

Method 200 includes an act of forwarding the packet to the receiving destination host (act 204). Act 204 can include the second load balancer forwarding the packet to the receiving destination host. For example, load balancer/NAT 104 can forward packet 156 to destination host 106B. Load balancer/NAT 104 can map destination address 116 (e.g., a virtual IP address) to address 114 (e.g., an IP address) corresponding to destination host 106B.

Method 200 includes an act of receiving the packet from the load balancer (act 205). Act 205 can include the receiving destination host receiving the packet from the second load balancer. For example, destination host 106B can receive packet 156 from load balancer/NAT 104.

Method 200 can also include an act of determining that the packet originated from the sending destination host. The act can include the second load balancer determining that the packet originated from sending destination host. For example, load balancer/NAT 104 can determine that packet 156 originated from destination host 107A.

Method 200 includes an act of detecting that the sending destination host is capable of packet modification (act 206). Act 206 can include the second load balancer detecting that the sending destination host is capable of packet modification. For example, load balancer/NAT 104 can detect (possibly based on source address 112) that destination host 107A is capable of packet modification.

Method 200 includes an act of formulating a connection mapping mapping the connection to an electronic address for the receiving destination host (act 207). Act 207 can include the second load balancer formulating a connection mapping for the connection. The connection mapping maps the connection to an electronic address for the receiving destination host. For example, load balancer/NAT 104 can formulate mapping 161. Mapping 161 maps connection ID 178 (an identifier for the connection) to address 114 (e.g., an IP address for destination host 106B). Load balancer/NAT 104 can create (if new) or access (if existing) connection ID 178 for the connection. Load balancer/NAT 104 can create connection ID 178 based on components of source address 112, destination address 116, and other packet contents that uniquely identify the connection (e.g., IP address and port).

Method 200 includes an act of sending the connection mapping to the sending destination host (act 208). Act 208 can include the second load balancer bypassing the first load balancer and sending the connection mapping directly to the electronic address for the sending destination host. For example, load balancer/NAT 104 is aware that destination host 107A is within network domain 108 and has an electronic address to reach destination host 107A. Thus, load balancer/NAT 104 can send mapping 161 directly to destination host 107A.

Method 200 includes an act of receiving a connection mapping (Act 209). Act 209 can include the sending destination host receiving the connection mapping for the connection directly from the second load balancer. For example, destination host 107A can receive connection mapping 161 from load balancer/NAT 104. Mapping 161 indicates how destination host 107A can bypass load balancer/NAT 104 and send packets for the connection (identified by connection ID 178) in a manner that bypassed network 102. For example, packets can be sent directly to destination host 106B or can be set to router 103 for routing to destination host 106B (without entering network 102).

Method 200 includes an act of utilizing the mapping to bypass a load balancer and send a second packet for the connection to the receiving destination host (act 210). Act 210 can include the sending destination host utilizing the connection mapping to bypass the second load balancer and send a second packet for the connection (either directly or through router 103) to the receiving destination host. For example, destination host 107A can utilize mapping 161 to bypass load balancer/NAT 104 and send packet 159 directly to destination host 106B. As depicted, packet 159 includes source address 113 and destination address 114. This information as well as other packet information can be used to map packet 159 to connection ID 178. Accordingly, packets 156 and 159 can be viewed as part of the same packet flow.

Method 200 includes an act of receiving the second packet for the connection directly from the sending destination host (act 211). Act 211 can include the receiving destination host receiving a packet for the connection directly from the sending destination host. For example, destination host 106B can receive packet 159 (either directly or through router 103) from destination host 107A.

Subsequently, it may be that a receiving destination host is to send a packet back to a sending destination host.

Method 200 includes an act of sending a third packet for the connection to the first plurality of destination hosts (act 212). Act 212 can include the receiving destination host sending a third packet onto the computer network, the third packet directed to the first plurality of destination hosts, the third packet including a source electronic address for the receiving destination host and a destination electronic address for the first plurality of destination hosts. For example, destination host 106B can send packet 157 onto network 102. As depicted, packet 157 includes source address 114 and destination address 113.

Components on network 102 can determine that router 103 is responsible for destination address 113. As such, components within network 102 (e.g., other routers) can route packet 157 to router 103. Alternately, router 103 can detect responsibility for packet 157 and take control of packet 157 before it enters onto network 102. In any event, router 103 can determine that address 113 (e.g., a virtual IP address corresponding collectively to destination hosts 107) is an address for load balancer/NAT 105. Accordingly, router 103 can send packet 157 to load balancer/NAT 105.

Method 200 includes an act of receiving the third packet for the connection directed to the first plurality of destination hosts (act 213). Act 213 can include the first load balancer receiving the third packet for the connection. For example, load balancer/NAT 105 can receive packet 157 from router 103. Source address 114 indicates that packet 157 originated from destination host 106B.

Method 200 includes an act of determining the third packet is to be forwarded to the sending destination host 107A (act 214). Act 214 can include the first load balancer determining that the first load balancer is to forward packets for the connection to the sending destination host. For example, load balancer/NAT 105 can determine that load balancer/NAT 105 is to forward packet 157 to destination host 107A. Load balancer/NAT 105 can use a load balancing algorithm (e.g., for a new connection) and/or refer to saved state (e.g., for an existing connection) to determine packet 157 is to be forwarded to destination host 107A. Load balancer/NAT 105 can map destination address 113 (e.g., a virtual IP address) to address 112 (e.g., an IP address) corresponding to destination host 107A.

Method 200 includes an act of forwarding the third packet to the sending destination host (act 215). Act 215 can include an act of the first load balancer forwarding the third packet to the sending destination host. For example, load balancer/NAT 105 can forward packet 157 to destination host 107A.

Method 200 includes an act of the sending destination host receiving the third packet (act 216). Act 216 can include the sending destination host receiving the third packet from the first load balancer. For example, destination host 107A can receive packet 157 from load balancer/NAT 105.

Method 200 can also include an act of determining that the third packet originated from the receiving destination host. The act can include the first load balancer determining that the packet originated from sending destination host. For example, load balancer/NAT 105 can determine that packet 157 originated from destination host 106B.

Method 200 can also include an act of identifying the receiving destination host as capable of placket modifications. The act can include the first load balancer identifying the receiving destination host as capable of placket modifications. For example, load balancer/NAT 105 can identifying destination host 106B as capable of packet modifications.

Method 200 includes an act of detecting that the receiving destination host is within the common network domain (act 217). Act 217 can include the first load balancer detecting that the receiving destination host is within the common network domain. For example, load balancer/NAT 105 can detect (possibly based on source address 114) that destination host 106B is in network domain 108.

Method 200 includes an act of formulating a second connection mapping mapping the connection to an electronic address for the sending destination (act 218). Act 218 can include the first load balancer formulating a second connection mapping for the connection. The second connection mapping maps the connection to an electronic address for the sending destination host. For example, load balancer/NAT 105 can formulate mapping 141. Mapping 141 maps connection ID 177 (an identifier for another connection) to address 112 (e.g., an IP address for destination host 107A). Load balancer/NAT 105 can create (if new) or access (if existing) connection ID 177 for the connection. Load balancer/NAT 105 can create connection ID 177 based on components of source address 114, destination address 113, and other packet contents that uniquely identify a connection (e.g., IP address and port).

Method 200 includes an act of sending the second connection mapping to the receiving destination host (act 219). Act 219 can include the first load balancer bypassing the second load balancer and sending the second connection mapping directly to the electronic address for the receiving destination host. For example, load balancer/NAT 105 is aware that destination host 106B is within network domain 108 and has an electronic address to reach destination host 106B. Thus, load balancer/NAT 105 can send mapping 141 directly to destination host 106B.

Method 200 includes an act of receiving the second connection mapping (act 220). Act 220 can include the receiving destination host receiving the second connection mapping for the connection directly from the first load balancer. For example, destination host 106B can receive connection mapping 141 from load balancer/NAT 105. Mapping 141 indicates how destination host 106B can bypass load balancer/NAT 105 and send packets for the connection (identified by connection ID 177) directly to destination host 107A.

Method 200 includes an act of utilizing the second mapping to bypass a load balancer and send a fourth packet for the connection to the sending destination host (act 221). Act 221 can include the receiving destination host utilizing the second connection mapping to bypass the first load balancer and send a fourth packet for the connection directly to the sending destination host. For example, destination host 106B can utilize mapping 132 to bypass load balancer/NAT 105 and send packet 158 directly to destination host 107A. As depicted, packet 158 includes source address 116 and destination address 112. This information as well as other packet information can be used to map packet 151 to connection ID 177. Accordingly, packets 157 and 158 can be viewed as part of the same packet flow (however different from the packet flow corresponding to connection ID 178).

Method 200 includes an act of receiving the fourth packet for the connection directly from the receiving destination host (act 222). Act 222 can include the sending destination host receiving a packet for the connection directly from the receiving destination host. For example, destination host 107A can receive packet 158 (either directly or through router 103) from destination host 106B.

Subsequent to mappings 161 and 141 being received, destination hosts 106B and 107A can bypass load balancers 104 and 105 for the duration of any further communication for the corresponding connections (identified by connection IDs 178 and 177). Accordingly, the resources of load balancers 104 and 105 are conserved. This conservation of resources makes additional resources available for use in balancing communication loads network domain 108.

Embodiments of the invention are equally applicable to Network Address Translation (“NAT”) devices and systems. A NAT can be addressable at a electronic (e.g., IP) address. The virtual electronic address can be used to hide (using IP masquerading) an address space (e.g., of private network IP address) of destination hosts. In accordance with embodiments of the invention, one destination host can be provided with an actual electronic (e.g., IP) address, from within the hidden address space, for another destination host. Use of the actual electronic address reduces the number of packets sent to the NAT (since communication using the actual electronic address bypasses the NAT).

Accordingly, embodiments of the invention can be used to offload the load of modifying packets back to the packet senders thereby allowing them to be removed from the forwarding path for subsequent packets. Load balancers and/or the NAT devices can handle the first few packets of each connection to formulate connection mappings and then are removed from further communication for the connections. For example, a load balancer or NAT device makes the corresponding load balancing or the NAT decision based on the first packet and then informs the sender of the data of the decision. From then on, the sender can directly send the data to the receiver without having to go through the load balancer or NAT.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed:

1. At a computer system including a packet modification system within a common network domain, the packet modification system including a packet modifier, a second packet modifier, a first plurality of destination hosts, and a second plurality of destination hosts, a method for communicating packets for a connection, the method comprising:
an act of the first packet modifier receiving a packet for a connection directed to the first plurality of destination hosts, the packet including an electronic address indicating that the packet originated from a sending destination host in the second plurality of destination hosts;
an act of the first packet modifier determining that the first packet modifier is to forward packets for the connection to a receiving destination host in the first plurality of destination hosts;
an act of the first packet modifier forwarding the packet to the receiving destination host;
an act of the first packet modifier determining that the packet originated from the sending destination host within the common network domain;
an act of the first packet modifier detecting that the sending destination host is capable of packet modifications;
an act of the first packet modifier formulating a connection mapping for the connection, the connection mapping mapping the connection to an electronic address for the receiving destination host; and
an act of the first packet modifier sending the connection mapping directly to the electronic address for the sending destination host such that the sending destination host can bypass the first packet modifier and send further packets for the connection directly to the receiving destination host.

2. The method as recited in claim 1, further comprising:
an act of the receiving destination host sending a second packet for the connection onto the network, the second packet directed to the sending destination host in the second plurality of destination hosts, the second packet including a destination electronic address that is forwarded via the second packet modifier, the second packet including a source electronic address indicating that the packet originated from the first plurality of destination hosts;
an act of the second packet modifier determining that the packet originated from the receiving destination host;
an act of the second packet modifier identifying the receiving destination host as capable of packet modifications; and
an act of the receiving destination host receiving a second connection mapping for the connection from the second packet modifier, the second connection mapping mapping the connection to the electronic address for the sending destination host, the second connection mapping indicating how the receiving destination host can bypass the second packet modifier and send further packets for the connection directly to the sending destination host.

3. The method as recited in claim 2, further comprising an act of the receiving destination host utilizing the second connection mapping to bypass the second packet modifier and send a third packet for the connection directly to the sending destination host.

4. The method as recited in claim 1, further comprising an act of the receiving destination host receiving one or more packets for the connection directly from the sending destination host subsequent to sending the connection mapping directly to the electronic address for the sending destination host.

5. The method as recited in claim 1, wherein the packet modification system is a load balancing system.

6. The method as recited in claim 1, wherein the packet modification system is a Network Address Translation (NAT) system.

7. The method as recited in claim 1, wherein the act of the first packet modifier receiving a packet for a connection directed to the first plurality of destination hosts comprises an act of the first packet modifier receiving a packet directed to a virtual Internet Protocol (IP) address that hides the actual IP address for destination hosts included in the first plurality of destination hosts.

8. The method as recited in claim 1, wherein the act of the first packet modifier receiving a packet for a connection directed to the first plurality of destination hosts comprises an act of the first packet modifier receiving a packet originated from a virtual Internet Protocol (IP) address that hides actual IP address for destination hosts included in the second plurality of destination hosts.

9. At a computer system including a packet modification system, the packet modification system including a first packet modifier, a second packet modifier, a first plurality of destination hosts, and a second plurality of destination hosts, a method for communicating packets for a connection, the method comprising:
an act of a sending destination host, in the first plurality of destination hosts, sending a packet onto the computer network, the packet for a connection directed to the second plurality of destination hosts, the packet including an destination electronic address for the second plurality of destination hosts, the packet including a source electronic address for the sending destination host;
an act of the sending destination host receiving a connection mapping for the connection directly from the second packet modifier, the connection mapping mapping the connection to an electronic address for a receiving destination host, included in the second plurality of destination hosts, the connection mapping indicating how the sending destination host can bypass the second packet modifier and send further packets for the connection directly to the receiving destination host; and
an act of the sending destination host utilizing the connection mapping to bypass the second packet modifier and send a second packet for the connection directly to the receiving destination host.

10. The method as recited in claim 9, further comprising:
an act of the first packet modifier receiving a further packet for the connection, the further packet including a destination electronic address for the sending destination host in the first plurality of destination hosts, the further packet including a source electronic address;
an act of the first packet modifier determining that first packet modifier is to forward packets for the connection to the sending destination host;
an act of the first packet modifier forwarding the third packet to the sending destination host;
an act of the first packet modifier detecting that the receiving destination host is within the common network domain;
an act of the first packet modifier formulating a second connection mapping for the connection, the second connection mapping mapping the connection to the electronic address for the sending destination host; and
an act of the first packet modifier sending the second connection mapping to the electronic address for the receiving destination host such that the receiving destination host can bypass the first packet modifier and send further packets for the connection directly to the sending destination host.

11. The method as recited in claim 10, wherein the act of the first packet modifier receiving third packet for the connection comprises an act of the first packet modifier receiving a packet directed to a virtual Internet Protocol (IP) address that hides actual IP addresses for destination hosts included in the first plurality of destination hosts.

12. The method as recited in claim 9, further comprising an act of the sending destination host receiving one or more packets for the connection directly from the receiving destination host subsequent to sending the second connection mapping directly to the electronic address for the receiving destination host.

13. The method as recited in claim 9, wherein the packet modification system is a load balancing system.

14. The method as recited in claim 9, wherein the packet modification system is a Network Address Transition (NAT) system.

15. The method as recite din claim 9, wherein an act of a sending destination host, in the first plurality of destination hosts, sending a packet onto the network comprises an act of the sending destination host sending a packet onto the Internet.

16. A computer system for off loading load balancing packet modifications, the computer system connected to a network, the computer system including:
one or more processors;
system memory; and
one or more computer storage devices having stored thereon computer-executable instructions representing a plurality of load balancers, each load balancer forwarding communication among plurality of corresponding destination hosts, wherein each load balancer is configured to:
receive packets for connections for corresponding destination hosts, the packets including source Internet Protocol (“IP”) addresses from sending destination hosts;
determine a corresponding receiving destination host that is to receive packets based on the connections;
forward packets to corresponding receiving destination hosts based the actual IP addresses for the corresponding receiving destination hosts;
detect when a sending destination host is within the common network domain;
formulate connection mappings connections when a sending destination host is detected as being within the common network domain, the connection mappings mapping connections to the electronic addresses for the corresponding receiving destination hosts; and
sending the connection maps directly to the IP address for the sending destination hosts such that the sending destination hosts can use the mappings to bypass the load balancer and send further packets for the connection directly to the receiving destination host; and wherein destination hosts are configured to:
send packets for connections for other destination hosts onto the network, the packets including a source IP address for the destination host and a destination IP address for the load balancer corresponding to the other destination host;
receiving a connection mappings for connections directly from load balancers for other destination hosts, the connection mappings mapping connections to IP address for the other destination hosts, the connection maps indicating how the destination host can bypass corresponding load balancers and send further packets for connections directly to the other destination hosts based on the mapped IP addresses; and
utilize connection maps to bypass load balancers and send further packets for connections directly to the other destination hosts.

17. The computer system as recited in claim 16, further including a router, wherein the router is configure to:
receive packets from the network; and
sending the packets to the appropriate load balancer.

18. The system as recited in claim 17, wherein the network is the Internet.

19. The system as recited in claim 17, wherein each destination host corresponding to a specified load balancer is an identical instance of a service.

20. The system as recited in claim 17, wherein the load balancers are performing Network Address Translation (NAT) for the plurality of destination hosts.
